(19) United States
(12) Patent Application Publication
(10) Pub. No.: US 2022/0064995 A1
(43) Pub. Date: Mar. 3, 2022

(54) Idling Switch Structure of Shaft of Electronic Lock

(71) Applicant: Jeff Chen, Chiayi City (TW)

(72) Inventor: Jeff Chen, Chiayi City (TW)

(21) Appl. No.: 17/004,526

(22) Filed: Aug. 27, 2020

(51) Int. Cl. E05B 63/00; E05B 27/00; E05B 49/00; E05B 47/00

(52) U.S. Cl. CPC E05B 63/0065; E05B 27/0017; E05B 49/00; E05B 47/0012; E05B 2047/0088; E05Y 2900/132; E05Y 2201/42; E05Y 2201/702; E05Y 2201/704; E05Y 2201/716; E05Y 2201/214; E05Y 2201/434

(57) ABSTRACT

An idling switch structure of a shaft of an electronic lock contains: a holding plate, a shell, an electric drive unit, a switching unit, and a manual rotation unit. The holding plate includes a peripheral fringe, multiple positioning posts, a fixing seat, two locating portions, a column, a receiving area, a limiting rib, an extension, and a bolt seat. The shell includes a covering space, multiple recesses, and a locking orifice. The electric drive unit includes a drive wheel, a motor body, and a transmission wheel having a central orifice and two rotation protrusions. The drive wheel has a central orifice, a tooth portion, and an actuation gear. The motor body has two stands and a worm. The switching unit includes a driven sheet, a slider, a first spring, a second spring, and a driving element. The manual rotation unit includes a lock bolt and a key.

### BACKGROUND OF THE INVENTION

### Field of the Invention

The present invention relates to an idling switch structure of a shaft of an electronic lock which is operated electrically or manually to close a deadbolt of a lock retractably, thus obtaining an idle switching mode of the shaft.

### Description of the Prior Art

A conventional electronic lock cannot be switched to an idle rotation of a shaft of a lock in a unlock mode (i.e. closing mode of a deadbolt). For example, when having a private party, it is troublesome to turn on/off the conventional electronic lock because guests come into or leave a house frequently.

The present invention has arisen to mitigate and/or obviate the afore-described disadvantages.

### SUMMARY OF THE INVENTION

The primary object of the present invention is to provide an idling switch structure of a shaft of an electronic lock which is capable of overcoming the shortcomings of the conventional electronic lock. For example, when having a private party, it is troublesome to turn on/off the conventional electronic lock because guests come into or leave a house.

To provide above-mentioned objects, an idling switch structure of a shaft of an electronic lock provided by the present invention contains: a holding plate, a shell; an electric drive unit including a drive wheel, a motor body, and a transmission wheel; a switching unit including a driven sheet, a slider, a first spring, a second spring, and a driving element; and a manual rotation unit including a lock bolt and a key.

Thereby, when the key is upward inserted into the accommodation orifice of the lock bolt, the lock bolt actuates the two rotating segments of the semi-circular portion to move the driven sheet and the slider forward and backward. The motor body of the electric drive unit drives the worm to actuate the drive wheel and the transmission wheel, and the two rotation protrusions of the transmission wheel abut against the actuated portion of the driven sheet by using the two tilted guide faces to push the slider. In a normal state, the actuated portion is located on a plane zone of the two rotation protrusions of the transmission wheel so that the slider moves forward to press the first and second springs retractably. Thus, the idling switch structure of the shaft of the electronic lock is operated electrically or manually to fix a deadbolt of the lock retractably, thus obtaining an idle switching mode of the shaft.

### BRIEF DESCRIPTION OF THE DRAWINGS

FIG. 1 is a perspective view showing the assembly of an idling switch structure of a shaft of an electronic lock according to a preferred embodiment of the present invention.

FIG. 2 is a perspective view showing the exploded components of the idling switch structure of the shaft of the electronic lock according to the preferred embodiment of the present invention.

FIG. 3 is another perspective view showing the exploded components of the idling switch structure of the shaft of the electronic lock according to the preferred embodiment of the present invention.

FIG. 3A is an amplified perspective view of a portion of FIG. 3.

FIG. 4 is a perspective view showing the assembly of the idling switch structure of the shaft of the electronic lock according to the preferred embodiment of the present invention.

FIG. 5 is a side plan view showing the operation of the idling switch structure of the shaft of the electronic lock according to the preferred embodiment of the present invention.

FIG. 6 is a cross sectional view showing the operation of the idling switch structure of the shaft of the electronic lock according to the preferred embodiment of the present invention.

FIG. 7 is another side plan view showing the operation of the idling switch structure of the shaft of the electronic lock according to the preferred embodiment of the present invention.

FIG. 8 is another cross sectional view showing the operation of the idling switch structure of the shaft of the electronic lock according to the preferred embodiment of the present invention.

FIG. 9 is also another side plan view showing the operation of the idling switch structure of the shaft of the electronic lock according to the preferred embodiment of the present invention.

FIG. 10 is also another cross sectional view showing the operation of the idling switch structure of the shaft of the electronic lock according to the preferred embodiment of the present invention.

FIG. 11 is still another side plan view showing the operation of the idling switch structure of the shaft of the electronic lock according to the preferred embodiment of the present invention.

FIG. 12 is still another cross sectional view showing the operation of the idling switch structure of the shaft of the electronic lock according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

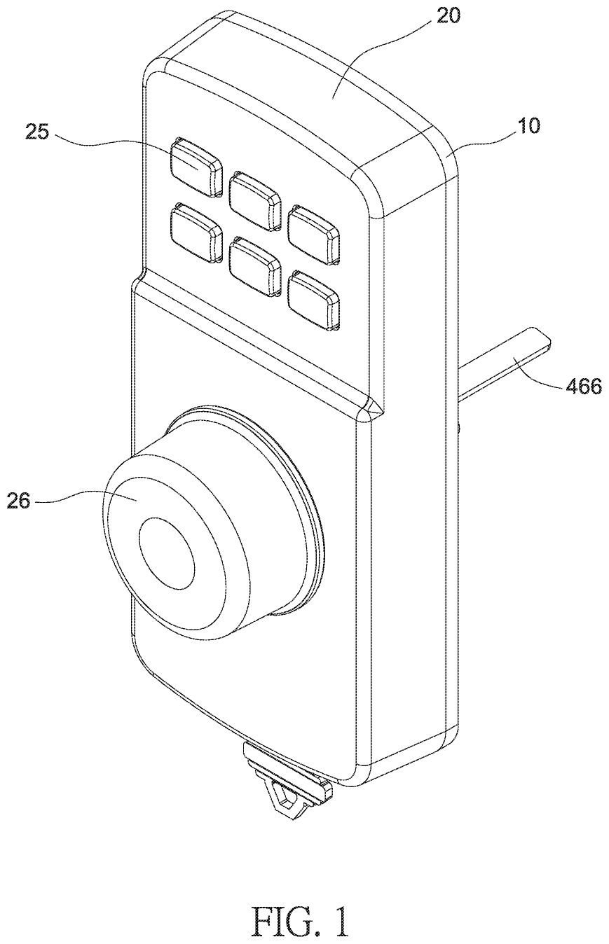

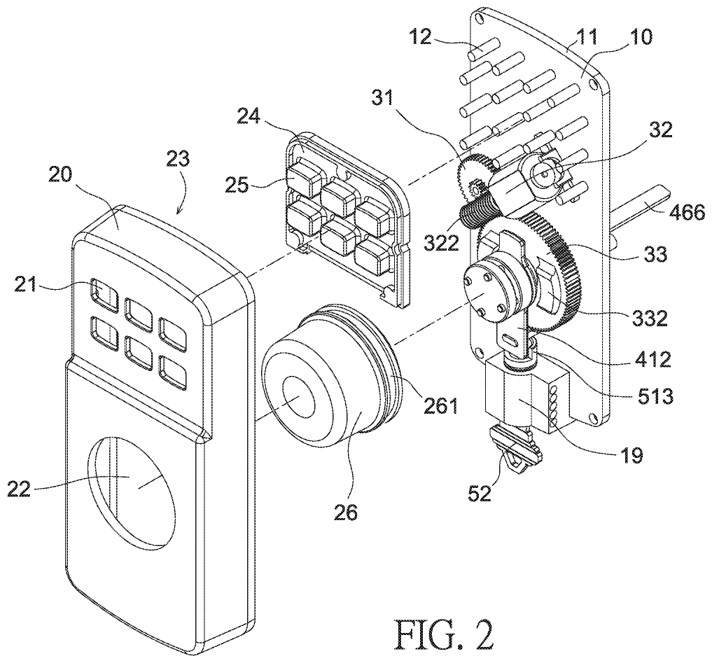

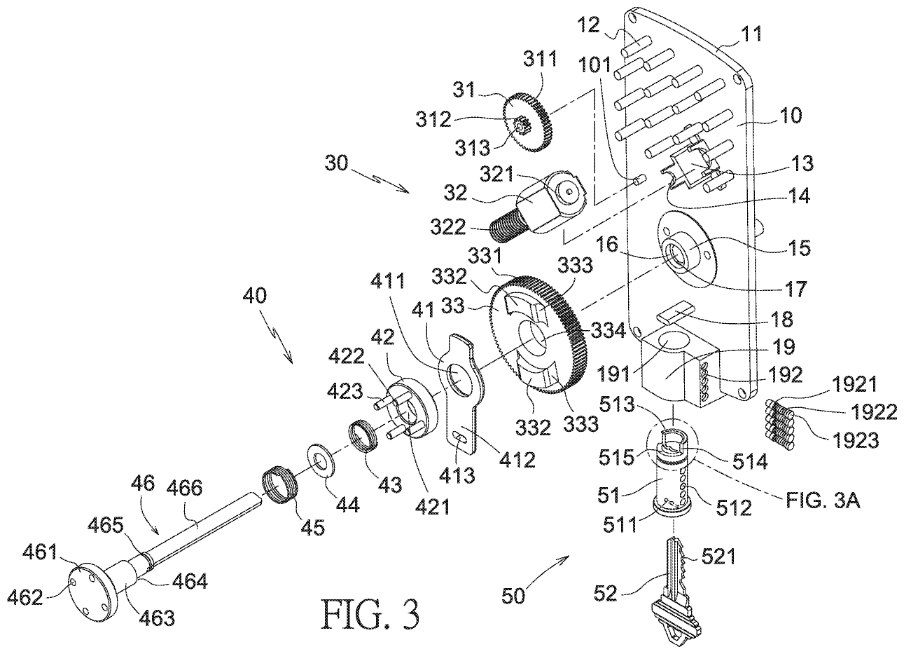

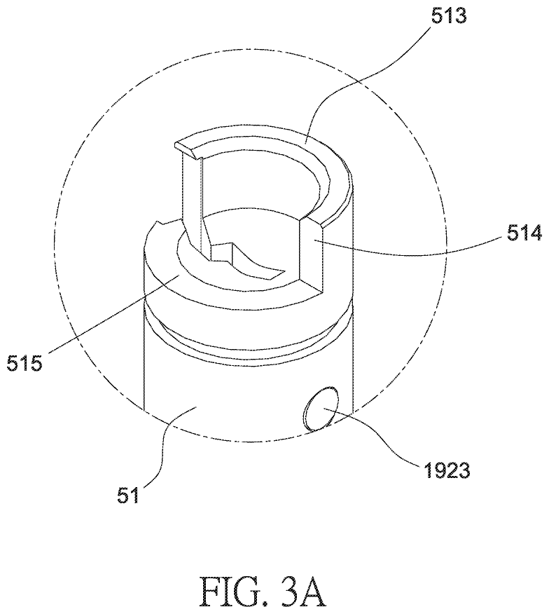

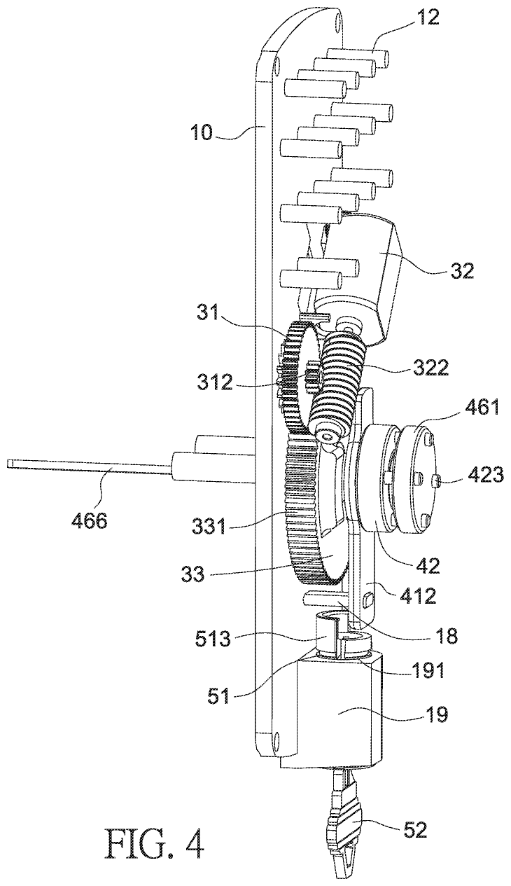

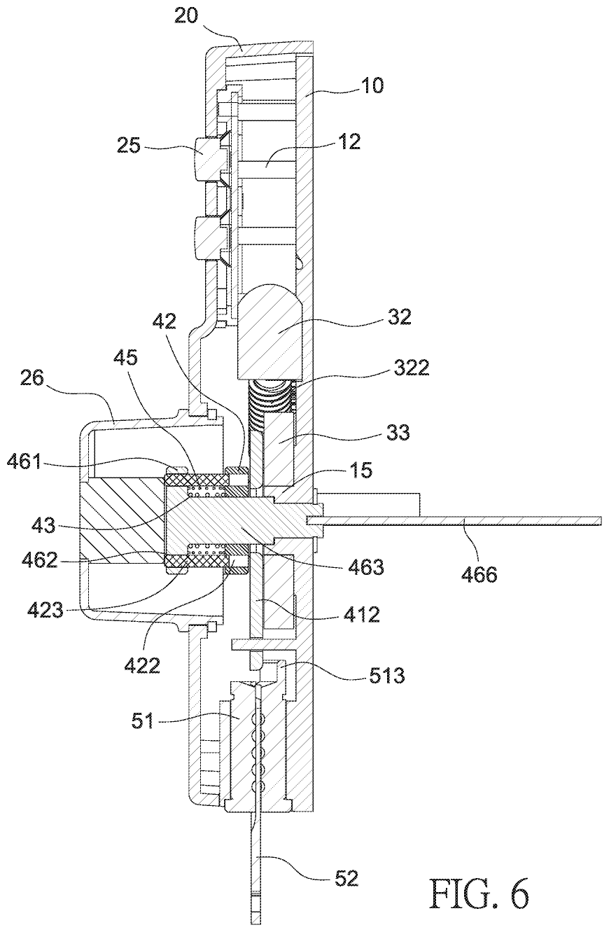

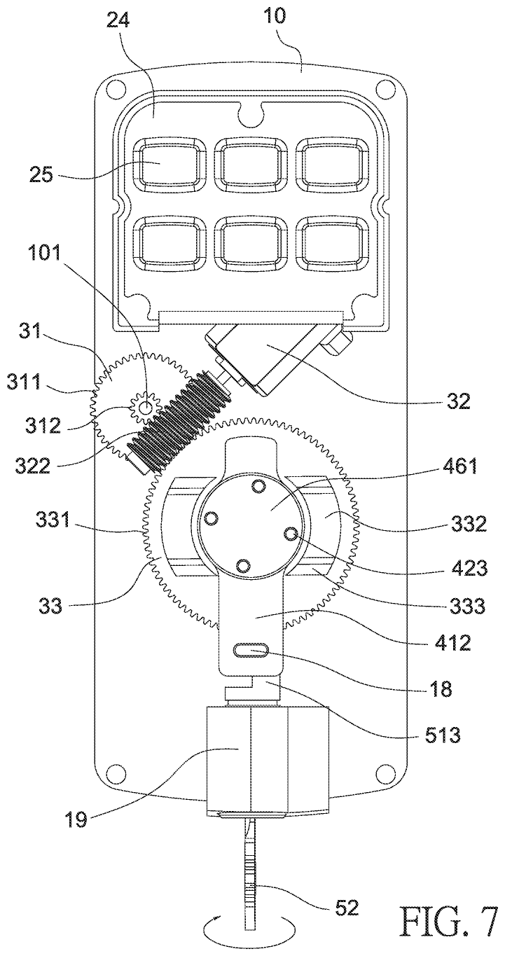

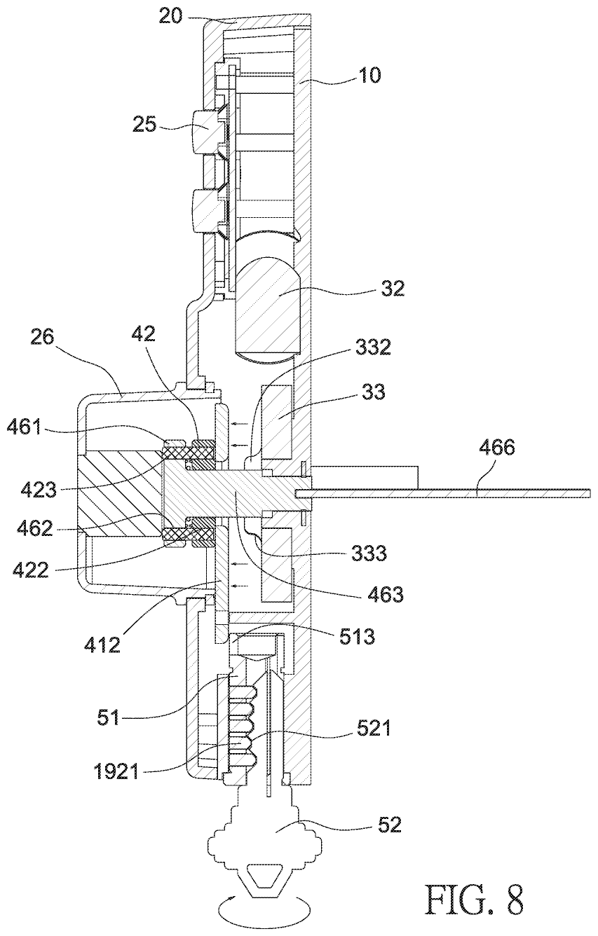

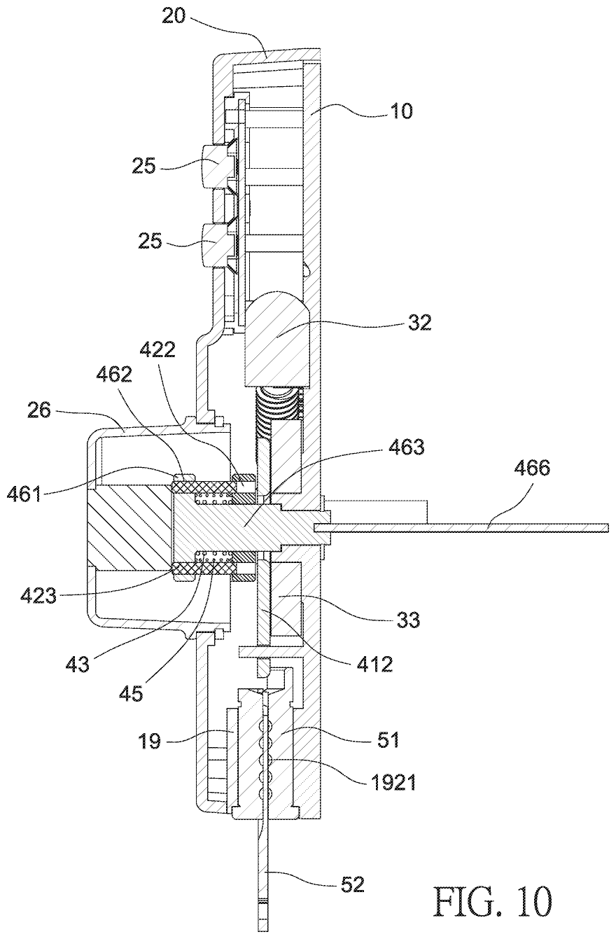

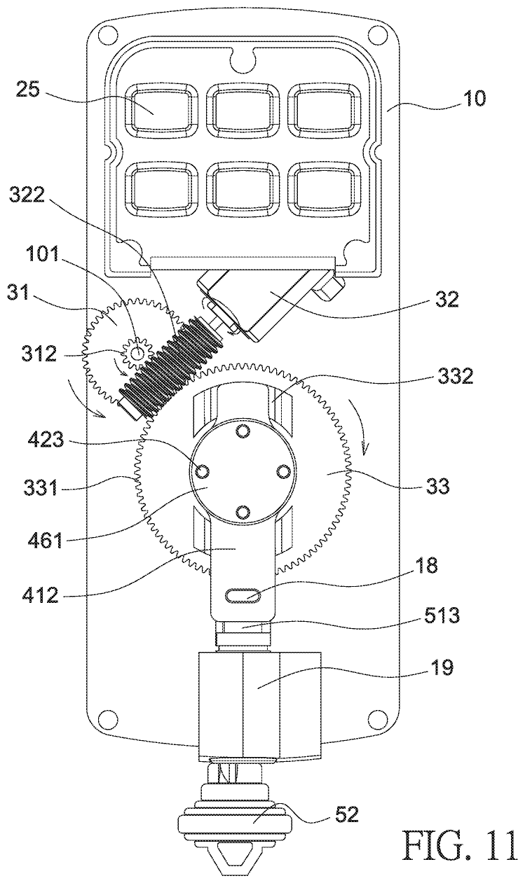

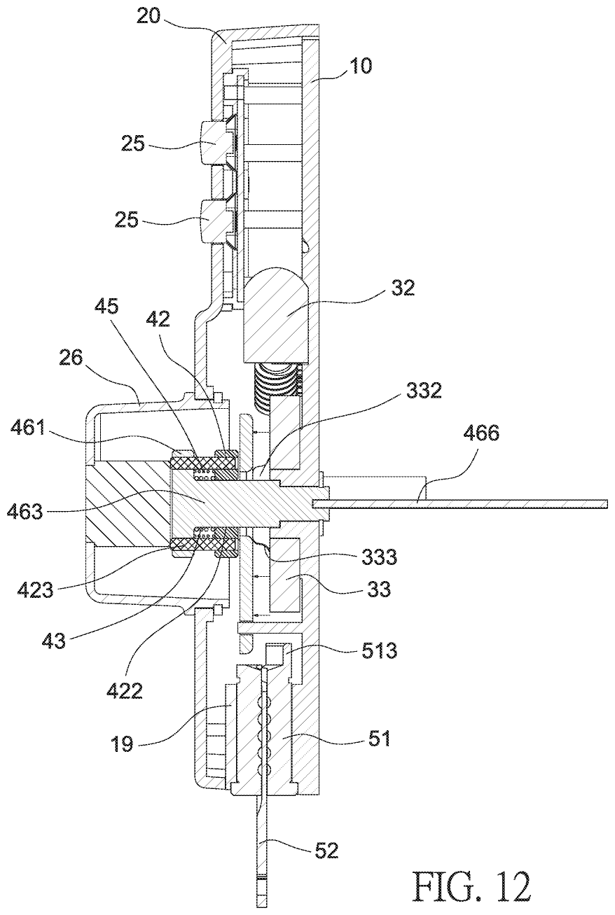

With reference to FIGS. 1-12, an idling switch structure of a shaft of an electronic lock according to a preferred embodiment of the present invention comprises:

a holding plate 10 including a peripheral fringe 11 formed on an outer wall of the holding plate 10, multiple positioning posts 12 extending upward from a side of a surface of the holding plate 10, a fixing seat 13 located below the multiple positioning posts 12, two locating portions 14 extending from two sides of a top of the fixing seat 13, a column 101 located beside the fixing seat 13, a mounting 15 located below the fixing seat 13, a receiving area 16 defined in the mounting 15, a limiting rib 17 formed on an inner wall of the receiving area 16, an extension 18 located below the mounting 15, a bolt seat 19 longitudinally formed below the extension 18 and a bottom of the holding plate 10, wherein the bolt seat 19 has a vertical groove 191 defined therein, multiple first through orifices 192 horizontally defined on a side of the bolt seat 19 with respect to the vertical groove 191, and a respective first through orifice 192 has a connection segment 1923 formed on a distal end thereof and connected with a resilient element 1922 and an abutting portion 1921 relative to the vertical groove 191;

a shell 20 including a covering space 23 formed in the shell 20 and configured to cover the holding plate 10 and to connect with the peripheral fringe 11 of the holding plate 10, multiple recesses 21 defined on a front end of the shell 20 and configured to extend out of multiple press portions 25 of a button pad 24, and an end of the button pad 24 being fixed on the multiple positioning posts 12 of the holding plate 10 opposite to the multiple recesses 21, a locking orifice 22 defined on a bottom of the shell 20 and configured to engage with an engagement portion 261 of a fixer 26;

an electric drive unit 30 including a drive wheel 31, a motor body 32, and a transmission wheel 33; wherein the drive wheel 31 has a first central orifice 313 defined on a center thereof and rotatably connected with the column 101 of the holding plate 10, a first tooth portion 311 formed around a peripheral side of the drive wheel 31, and an actuation gear 312 extending from a center of the first tooth portion 311; the motor body 32 has two stands 321 formed on two sides thereof and configured to position the motor body 32 on the fixing seat 13, wherein the two stands 321 are mounted on the two locating portions 14 of the fixing seat 13, and the motor body 32 has a worm 322 extending from an end thereof; the transmission wheel 33 has a second central orifice 334 defined on a center thereof and rotatably connected with the mounting 15 of the holding plate 10, two rotation protrusions 322 extending from a front surface of the transmission wheel 33 and located at 90 degree to each other, wherein a respective rotation protrusion 332 has two tilted guide faces 333 formed on two sides thereof, and a second tooth portion 331 formed around a peripheral side of the transmission wheel 33 so that the worm 322 meshes and actuates the actuation gear 312 to rotate, and the actuation gear 312 drives the first tooth portion 311 to mesh with and to drive the second tooth portion 331;

a switching unit 40 including a driven sheet 41, a slider 42, a first spring 43, a second spring 45, and a driving element 46; wherein the driven sheet 41 has a first aperture 411 defined on a center thereof and aligning with the second central orifice 334 of the transmission wheel 33, an actuated portion 412 extending on a bottom of the driven sheet 41 and configured to touch or not touch the respective rotation protrusion 332 of the transmission wheel 33, such that the respective rotation protrusion 332 drives the driven sheet 41 to move forward and backward when the transmission wheel 33 rotates to an angle, wherein the driven sheet 41 further has a cutout 413 defined on a bottom thereof and corresponding to the extension 18 of the holding plate 10; the slider 42 has a second through orifice 421 corresponding to the first aperture 411 of the driven sheet 41, and multiple sliding orifices 422 defined around the slider 42, wherein a respective sliding orifice 422 is configured to slidably receive a guide stem 423; the first spring 43 and the second spring 45 are disposed on a side of the slider 42; the driving element 46 has an acting segment 461, multiple coupling orifices 462 formed around the acting segment 461 and mating with the multiple sliding orifices 422 of the slider 42, such that an end of the guide stem 423 of the respective sliding orifice 422 is connected with a respective coupling orifice 462, and the acting segment 461 has a slide section 463 facing the transmission wheel 33, the slide section 463 has a stepped shoulder 464 extending from an end thereof and having a retaining rib 465 formed on a distal end of the stepped shoulder 464, and a post 466 extends from the retaining rib 465 so that the slide section 463 extends through the first spring 43, the second spring 45, the second through orifice 421 of the slider 42, the first aperture 411 of the driven sheet 41, and the second central orifice 334 of the transmission wheel 33 to engage with the limiting rib 17 of the receiving area 16 of the holding plate 10 by using the stepped shoulder 464, the retaining rib 465 extends outside and is engaged by a limitation piece 44, and the driving element 46 and above-mentioned components are connected with the mounting 15 of the holding plate 10;

a manual rotation unit 50 including a lock bolt 51 and a key 52; wherein the lock bolt 51 is rotatably received in the vertical groove 191 of the bolt seat 19 of the holding plate 10, the lock bolt 51 has multiple second apertures 512 defined on a side thereof and mating with the multiple first through orifices 192 of the bolt seat 19, an accommodation orifice 511 defined on a bottom of the lock bolt 51 and configured to accommodate the key 52, wherein the key 52 has a serrated portion 521 formed on a side thereof and corresponding to the multiple second apertures 512; when the serrated portion 521 matches with the abutting portion 1921, the lock bolt 51 is rotated with respect to the bolt seat 19, wherein the lock bolt 51 has a semi-circular portion 513 formed on a top thereof, a rotating segment 514 formed on two ends of the semi-circular portion 513, a turning space 515 defined relative to the two rotating segments 514 and aligning with the actuated portion 412 of the driven sheet 41, such that when the key 52 actuates the lock bolt 51 to rotate, the rotating segment 514 drives the actuated portion 412 of the driven sheet 41 so that the driven sheet 41 and the slider 42 moves forward and backward.

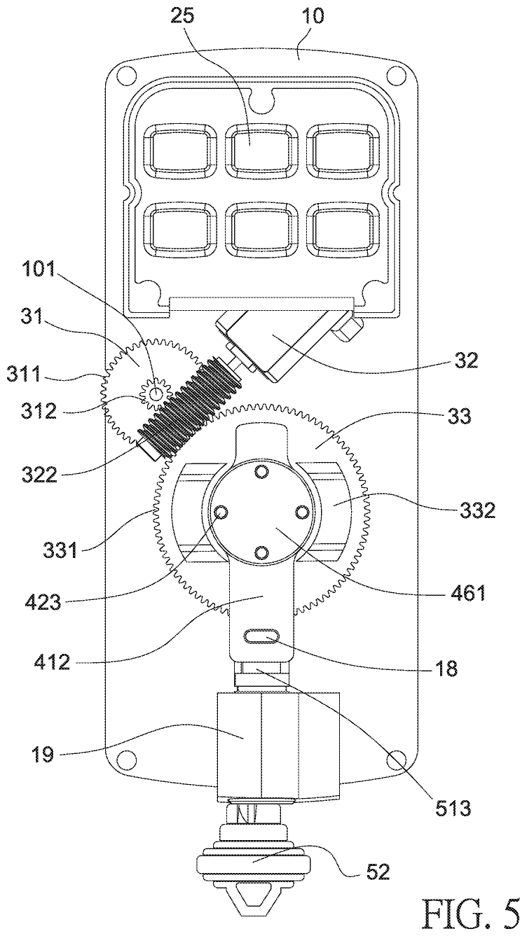

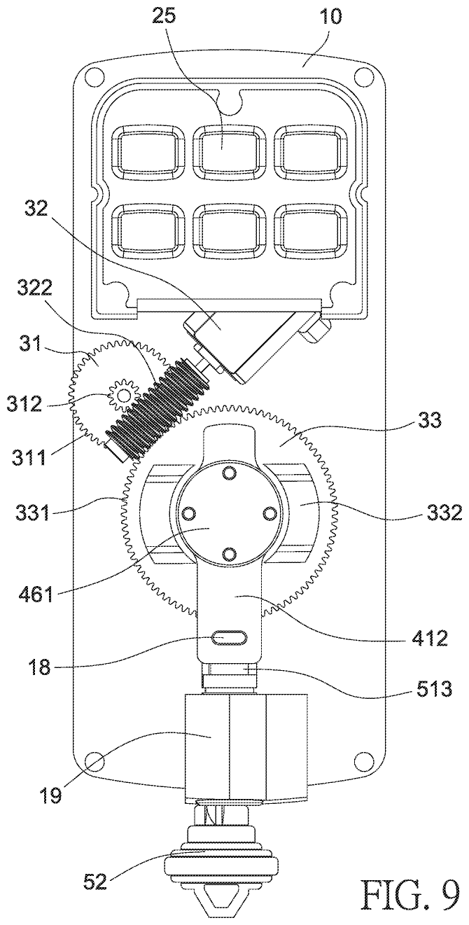

Referring to FIGS. 5-8, when the key 52 is upward inserted into the accommodation orifice 511 of the lock bolt 51, the lock bolt 51 actuates the two rotating segments 514 of the semi-circular portion 513 to move the driven sheet 41 and the slider 42 forward and backward. As shown in FIGS. 9-12, the motor body 32 of the electric drive unit 30 drives the worm 322 to actuate the drive wheel 31 and the transmission wheel 33, and the two rotation protrusions 332 of the transmission wheel 33 abut against the actuated portion 412 of the driven sheet 41 by using the two tilted guide faces 333 to push the slider 42. In a normal state, the actuated portion 412 is located on a plane zone of the two rotation protrusions 332 of the transmission wheel 33 so that the slider 42 moves forward to press the first and second springs retractably. Thus, the idling switch structure of the shaft of the electronic lock is operated electrically or manually to fix a deadbolt (not shown) of the lock retractably, thus obtaining an idle switching mode of the shaft.

While various embodiments in accordance with the present invention have been shown and described, it is clear to those skilled in the art that further embodiments may be made without departing from the scope of the present invention.

What is claimed is:

1. An idling switch structure of a shaft of an electronic lock comprising:
a holding plate includes a peripheral fringe formed on an outer wall of the holding plate, multiple positioning posts extending upward from a side of a surface of the holding plate, a fixing seat located below the multiple positioning posts, two locating portions extending from two sides of a top of the fixing seat, a column located beside the fixing seat, a mounting located below the fixing seat, a receiving area defined in the mounting, a limiting rib formed on an inner wall of the receiving area, an extension located below the mounting, a bolt seat longitudinally formed below the extension and a bottom of the holding plate, the bolt seat having a vertical groove defined therein, multiple first through orifices horizontally defined on a side of the bolt seat with respect to the vertical groove, and a respective first through orifice having a connection segment formed on a distal end thereof and connected with a resilient element and an abutting portion relative to the vertical groove;
a shell includes a covering space formed in the shell and configured to cover the holding plate and to connect with the peripheral fringe of the holding plate, multiple recesses defined on a front end of the shell and configured to extend out of multiple press portions of a button pad, and an end of the button pad being fixed on the multiple positioning posts of the holding plate opposite to the multiple recesses, a locking orifice defined on a bottom of the shell and configured to engage with an engagement portion of a fixer;
an electric drive unit includes a drive wheel, a motor body, and a transmission wheel; wherein the drive wheel has a first central orifice defined on a center thereof and rotatably connected with the column of the holding plate, a first tooth portion formed around a peripheral side of the drive wheel, and an actuation gear extending from a center of the first tooth portion; the motor body has two stands formed on two sides thereof and configured to position the motor body on the fixing seat, wherein the two stands are mounted on the two locating portions of the fixing seat, and the motor body has a worm extending from an end thereof; the transmission wheel has a second central orifice defined on a center thereof and rotatably connected with the mounting of the holding plate, and two rotation protrusions extending from a front surface of the transmission wheel and located at 90 degree to each other, wherein a respective rotation protrusion has two tilted guide faces formed on two sides thereof, and a second tooth portion formed around a peripheral side of the transmission wheel;
a switching unit includes a driven sheet, a slider, a first spring, a second spring, and a driving element; wherein the driven sheet has a first aperture defined on a center thereof and aligning with the second central orifice of the transmission wheel, an actuated portion extending on a bottom of the driven sheet and configured to touch or not touch the respective rotation protrusion of the transmission wheel, such that the respective rotation protrusion drives the driven sheet to move forward and backward, wherein the driven sheet further has a cutout defined on a bottom thereof and corresponding to the extension of the holding plate; the slider has a second through orifice corresponding to the first aperture of the driven sheet, and the slider has multiple sliding orifices defined around the slider, wherein a respective sliding orifice is configured to slidably receive a guide stem; the first spring and the second spring are disposed on a side of the slider; the driving element has an acting segment, multiple coupling orifices formed around the acting segment and mating with the multiple sliding orifices of the slider, such that an end of the guide stem of the respective sliding orifice is connected with a respective coupling orifice, and the acting segment has a slide section facing the transmission wheel, the slide section has a stepped shoulder extending from an end thereof and having a retaining rib formed on a distal end of the stepped shoulder, and a post extends from the retaining rib so that the slide section extends through the first spring, the second spring, the second through orifice of the slider, the first aperture of the driven sheet, and the second central orifice of the transmission wheel to engage with the limiting rib of the receiving area of the holding plate by using the stepped shoulder, the retaining rib extends outside and is engaged by a limitation piece, and the driving element and above-mentioned components are connected with the mounting of the holding plate; and
a manual rotation unit includes a lock bolt and a key; wherein the lock bolt being rotatably received in the vertical groove of the bolt seat of the holding plate, the lock bolt having multiple second apertures defined on a side thereof and mating with the multiple first through orifices of the bolt seat, an accommodation orifice defined on a bottom of the lock bolt and configured to accommodate the key, wherein the key has a serrated portion formed on a side thereof and corresponding to the multiple second apertures; when the serrated portion matches with the abutting portion, the lock bolt is rotated with respect to the bolt seat, wherein the lock bolt has a semi-circular portion formed on a top thereof, a rotating segment formed on two ends of the semi-circular portion, a turning space defined relative to the two rotating segments and aligning with the actuated portion of the driven sheet, such that when the key actuates the lock bolt to rotate, the rotating segment drives the actuated portion of the driven sheet so that the driven sheet and the slider moves forward and backward.
